(19) United States
(12) Patent Application Publication
(10) Pub. No.: US 2005/0061147 A1
(43) Pub. Date: Mar. 24, 2005

(54) Chemisorbent system for abatement of effluent species

(76) Inventors: Paul J. Marganski, Seymour, CT (US); Joseph D. Sweeney, Brookfield, CT (US)

Correspondence Address: ATMI, INC., 7 COMMERCE DRIVE, DANBURY, CT, 06810, US

(21) Appl. No.: 10/665,870

(22) Filed: Sep. 18, 2003

(51) Int. Cl. B01D 53/02

(52) U.S. Cl. 95/116; 95/131; 96/132; 96/153

(57) ABSTRACT

A dry scrubbing system for treatment of effluent from an upstream effluent-generating process. The dry scrubbing system accommodates operation in a process window involving substantial variation in process conditions, e.g., flow rate and/or concentration, of scrubbable gas species in the effluent. Multiple scrubbing media are utilized in the dry scrubbing system, each optimal in a regime of the operating window, and together ensuring at least a predetermined level of removal of scrubbable gas species over the entire operating window. In a specific aspect, gaseous phosphorus in the effluent is abated by use of potassium hydroxide as an active abatement agent.

### BACKGROUND OF THE INVENTION

1. Field of the Invention

This invention relates generally to chemisorbent systems for abatement of effluent, e.g., for removal of hydride gas species and/or acid gas species therefrom. In a specific aspect, the invention relates to chemisorbent systems for abatement of phosphorus and hydride gases.

2. Description of the Related Art

In semiconductor manufacturing processes for III-V devices, in which chemical vapor deposition (CVD) is utilized for deposition of the III-V semiconductor film, phosphine is commonly employed as a feed gas to the CVD reactor.

In such applications, the high temperatures that are employed in the CVD reactor cause much of the phosphine to decompose to elemental phosphorus and hydrogen gases. A small amount of the phosphorus is deposited on the wafer surface, while most of the gaseous phosphorus is swept out of the CVD reactor by purge and/or ballast gases. The effluent containing the gaseous phosphorus then passes downstream to a vacuum pump that is employed to maintain pressure in the CVD reactor at a suitably low level, and flows through the pump and subsequently through a cold trap to an abatement system in which hazardous and toxic gas species in the effluent stream are removed.

In the cold trap, much of the gaseous phosphorus in the effluent is removed from the vapor phase and condensed on the internal surfaces of the cold trap, in solid form. However, at temperatures that are most convenient for cold trap operation (typically ˜10-15° C., the temperature of cooling water that is typically available in semiconductor manufacturing facilities), the phosphorus has sufficient vapor pressure so that part-per-million (ppm) levels of phosphorus are retained in the gas phase and are carried on to the abatement system.

Abatement systems commonly employ chemisorbents for removing toxic and hazardous gas species from semiconductor manufacturing effluents. Recently, it has been discovered that common chemisorbents such as copper carbonate and copper oxide that are used for abatement of III-V process gases such as arsine and phosphine, do not effectively abate gaseous phosphorus. Additionally, it is known that materials such as molecular sieves, even when impregnated with strong bases such as lithium hydroxide, do not effectively remove gaseous phosphorus. The same inability to abate gaseous phosphorus is also characteristic of various impregnated activated carbon materials.

As a result of the above-described deficiency of conventional abatement systems, the gaseous phosphorus passes through the effluent treatment operation unaffected and unremoved. This is a highly undesirable occurrence. Not only is phosphorus gas highly toxic, but phosphorus gas can also be misinterpreted as being phosphine by effluent gas analyzers that are located downstream of the abatement system. In consequence, when phosphorus gas passes through the abatement system untreated, and is interpreted as phosphine in the gas analyzer downstream of the abatement device, the user may simply shut the chemisorbent bed down, mistakenly thinking that phosphine has broken through the chemisorbent, and that the chemisorbent has been exhausted. Thus, the phosphorus gas acts as a false indicator of breakthrough of phosphine from the chemisorbent bed in the abatement system.

The user then may discard the chemisorbent, supposing same to be depleted of phosphine removal ability. This premature disposal of the chemisorbent produces a substantial wastage of still-effective material, which adversely affects the efficiency and economics of the semiconductor manufacturing operation.

One solution to the foregoing problem is to reduce the concentration of gaseous phosphorus, by reducing the operating temperature of the cold trap so that it achieves higher levels of phosphorus removal, below ppm levels. However, such approach can be quite costly, since a separate chiller and cooling fluid are typically required to reduce the temperature of the effluent to a level significantly below that of the cooling water otherwise available in the semiconductor manufacturing facility.

Accordingly, it would be a substantial advance in the art to provide an abatement system utilizing chemisorbent media that effectively abates gaseous phosphorus as well as hydride gases commonly found in effluents of III-V semiconductor manufacturing processes, and that avoids the necessity of modifying the cold trap or adjusting the operating conditions of the semiconductor manufacturing facility.

Apart from the foregoing, and more generally, it would be a substantial advance in the art to provide a method of removing gaseous phosphorus from an effluent containing same, in a simple manner and at higher levels of removal than are achievable by the techniques and approaches of the prior art.

### SUMMARY OF THE INVENTION

The present invention relates to chemisorbent treatment of effluent to remove undesired species therefrom.

In one aspect, the invention relates to a dry scrubbing system for treatment of effluent from an upstream effluent-generating process to remove scrubbable gas species therefrom, within an operating window of process conditions involving substantial variation in flow rate and/or concentration of the scrubbable gas species during operation of the system, such system comprising:
a first dry scrubbing material arranged for contact with the effluent, wherein the first dry scrubbing material is (i) effective under process conditions constituting a first operating regime within the operating window of process conditions to achieve at least a predetermined level of removal of the scrubbable gas species from the effluent, and (ii) less effective outside of the first operating regime within said operating window of process conditions for removal of the scrubbable gas species from the effluent;
a second dry scrubbing material arranged for contact with said effluent, wherein the second dry scrubbing material is (i) effective under process conditions constituting a second operating regime within the operating window of process conditions to achieve at least the predetermined level of removal of the scrubbable gas species from the effluent, and (ii) less effective outside of the second operating regime within the operating window of process conditions for removal of the scrubbable gas species from the effluent; and
wherein effluent from the upstream effluent-generating process is arranged to contact both of the first dry scrubbing material and the second dry scrubbing material, and the first dry scrubbing material and the second dry scrubbing material together are effective to achieve at least the predetermined level of removal of the scrubbable gas species from the effluent, over the entire range of process conditions in the process operating window.

In another aspect, the invention relates to a system for abating a gaseous phosphorus-containing effluent, comprising a dry scrubbing unit arranged for contact with the effluent, wherein the dry scrubbing unit comprises potassium hydroxide.

The invention relates in a further aspect to a method of abating gaseous phosphorus in an effluent including same, such method comprising contacting the effluent with potassium hydroxide.

A still further aspect of the invention relates to a method of treatment of effluent from an upstream effluent-generating process to remove scrubbable gas species therefrom, within an operating window of process conditions involving substantial variation in flow rate and/or concentration of the scrubbable gas species, such method comprising:
contacting the effluent with a first dry scrubbing material, wherein the first dry scrubbing material is (i) effective under process conditions constituting a first operating regime within the operating window of process conditions to achieve at least a predetermined level of removal of the scrubbable gas species from the effluent, and (ii) less effective outside of the first operating regime within the operating window of process conditions for removal of the scrubbable gas species from the effluent;
contacting the effluent with a second dry scrubbing material, wherein the second dry scrubbing material is (i) effective under process conditions constituting a second operating regime within the operating window of process conditions to achieve at least the predetermined level of removal of the scrubbable gas species from the effluent, and (ii) less effective outside of the second operating regime within the operating window of process conditions for removal of the scrubbable gas species from the effluent; and
wherein the effluent contacts both of the first dry scrubbing material and the second dry scrubbing material, and the first dry scrubbing material and the second dry scrubbing material together are effective to achieve at least the predetermined level of removal of the scrubbable gas species from the effluent, over the entire range of process conditions in the process operating window.

The two or more scrubbing media species can be layered, mixed, blended, or otherwise combined in ratios suitable for the specific process effluent gas species being targeted.

In another aspect, the invention relates to a method of treating effluent to provide a predetermined level of removal of at least one undesired species from the effluent, wherein the undesired species has a variable presence, concentration and/or flow rate constituting differing regimes of effluent treatment operation, said method comprising contacting the effluent with at least two different sorptive media for removal of said at least one undesired species, wherein each sorptive medium has differing removal efficiency for undesired species in at least two of said regimes of effluent treatment operation, and wherein said different sorptive media in combination provide a predetermined removal efficiency for said undesired species.

Other aspects, features and embodiments of the invention will be more fully apparent from the ensuing disclosure and appended claims.

### BRIEF DESCRIPTION OF THE DRAWINGS

FIG. 1 is a schematic representation of a semiconductor manufacturing facility including a III-V process unit and effluent treatment units downstream thereof, in accordance with one embodiment of the invention.

### DETAILED DESCRIPTION OF THE INVENTION, AND PREFERRED EMBODIMENTS THEREOF

The present invention embodies the discovery that a dry scrubbing system can advantageously be operated in a highly optimal manner for treatment of effluent from an upstream effluent-generating process to remove scrubbable gas species therefrom, within an operating window of process conditions involving substantial variation in flow rate and/or concentration of the scrubbable gas species during operation of the system, when the system is arranged so that it includes:
a first dry scrubbing material arranged for contact with the effluent, wherein the first dry scrubbing material is (i) effective under process conditions constituting a first operating regime within the operating window of process conditions to achieve at least a predetermined level of removal of the scrubbable gas species from the effluent, and (ii) less effective outside of the first operating regime within said operating window of process conditions for removal of the scrubbable gas species from the effluent;
a second dry scrubbing material arranged for contact with the effluent, wherein the second dry scrubbing material is (i) effective under process conditions constituting a second operating regime within the operating window of process conditions to achieve at least the predetermined level of removal of the scrubbable gas species from the effluent, and (ii) less effective outside of the second operating regime within the operating window of process conditions for removal of the scrubbable gas species from the effluent; and
wherein effluent from the upstream effluent-generating process is arranged to contact both of the first dry scrubbing material and the second dry scrubbing material, and the first dry scrubbing material and the second dry scrubbing material together are effective to achieve at least the predetermined level of removal of the scrubbable gas species from the effluent, over the entire range of process conditions in the process operating window.

The scrubbable gas species processed by the abatement system by such arrangement can be of any suitable types, e.g., as generated in semiconductor manufacturing facilities. For example, the scrubbable gas species can include acid gas species, hydride gas species, halide gas species, organometallic gas species, etc., with specific effluent gas species including, without limitation, CO₂, H₂S, COS, mercaptans, arsine, phosphine, germane, diborane, boron trifluoride, boron trichloride, diborane, silane, halosilanes, nitrogen oxides, tertiary-butyl arsine (TBA), and tertiary-butyl phosphine (TBP), trimethylgallium (TMG), hydrogen, hydrogen fluoride, chlorine, hydrogen chloride, sulfur hexafluoride, etc.

The invention in one specific aspect contemplates the use of potassium hydroxide (KOH) as an effective removal agent for both gaseous phosphorus and phosphine in a gas scrubbing operation. Potassium hydroxide may be employed for such purpose as an impregnated active scrubbing agent on a support material.

The support material for such purpose can be in a particulate or divided form, or alternatively in any other suitable form. The support can be of any suitable type, with materials such as molecular sieve (or other zeolitic material), alumina, silica, activated carbon, or metal oxide being variously useful in the practice of the invention.

One preferred support material is a metal oxide extrudate, e.g., a copper oxide/zinc oxide extrudate. Potassium hydroxide impregnated copper oxide/zinc oxide extrudates have shown to achieve extremely high efficiency in removing gaseous phosphorus as well as phosphine from gas streams containing same.

When in a particulate form, the potassium hydroxide-impregnated support material can be of any suitable size and shape. In one embodiment, the particles have dimensions in a range of from about 1 to about 15 millimeters (e.g., diameter or major length dimensions), and can be of spherical shape, cylindrical shape, cubic shape, rectangular parallelepiped shape, or other geometrically regular or irregular conformation.

Particles of the potassium hydroxide-impregnated support material can be employed to form a bed through which the gaseous phosphorus-containing effluent is flowed, with the bed being disposed in a suitable sorbent vessel, as hereinafter more fully described.

In III-V semiconductor manufacturing operations, gaseous phosphorus is a very minor fraction of the effluent in relation to hydrides that must also be abated. The invention therefore contemplates the use of potassium hydroxide impregnated materials, as described above, for chemisorbent removal of phosphorus gas, in combination with a chemisorbent material having a high intrinsic capacity for hydride gas species.

The hydride gas chemisorbent material that is used in combination with the gaseous phosphorus chemisorbent can be of any suitable type commonly employed for such purpose in the art. Hydride gas chemisorbent materials useful in the broad practice of the invention include, for example, copper carbonate, basic copper carbonate, copper oxide, copper hydroxide, copper sulfate, zinc oxide, nickel oxide, potassium hydroxide, magnesium hydroxide, potassium iodide, silver oxide, activated carbon, molecular sieve, alumina, and silica gel.

The invention also contemplates in various specific embodiments the removal of acid gas species in the effluent, using acid gas scrubbing materials such as copper carbonate, basic copper carbonate, copper hydroxide, copper sulfate, lithium hydroxide, potassium thiosulfate, sodium thiosulfate, iron oxide, basic zinc oxide, calcium hydroxide, manganese oxide, calcium oxide, activated carbon, aluminum silicate, molecular sieve, aluminum oxide, silica gel, and potassium hydroxide.

Other embodiments of the invention include use of dry scrubbing materials for removal of gaseous halide species, gaseous organometallic species, etc.

In a particularly preferred arrangement, a potassium hydroxide-impregnated material is utilized in one zone of a multi-zone chemisorbent system, in combination with a hydride gas chemisorbent material in another zone of the multi-zone chemisorbent system.

As a further and preferred aspect of the invention, the aforementioned hydride chemisorbent material may be provided in a main bed of the chemisorbent system, in combination with a polishing bed of a same or different hydride chemisorbent material downstream from the main bed. This upstream main bed/downstream polishing bed arrangement ensures residual hydride removal, and can be utilized in combination with a bed of potassium hydroxide-impregnated material, to achieve an effluent that is substantially free of hydride and gaseous phosphorus species, to below detectable limits, e.g., below 0.05 ppm concentrations of hydrides and gaseous phosphorus.

In a multi-zone chemisorbent arrangement, the potassium hydroxide-impregnated material may be arranged in any suitable order, in relation to the other zone(s) of chemisorbent material(s).

A particularly preferred arrangement includes a main bed of hydride chemisorbent material at a first upstream location, e.g., at the inlet end of a sorbent vessel, an intermediate bed of potassium hydroxide-impregnated material for removal of gaseous phosphorus, and a downstream hydride removal polishing bed, e.g., at the outlet end of a sorbent vessel. The downstream hydride removal polishing bed can be formed of a same or a different hydride chemisorbent material (relative to the hydride removal chemisorbent material in the main bed at the first upstream location).

Alternatively, the polishing bed of hydride chemisorbent may be disposed in a separate vessel downstream from a vessel containing the main hydride chemisorbent and the potassium hydroxide-impregnated material.

As a still further alternative, successive vessels may be deployed through which the effluent is sequentially flowed, with the main hydride chemisorbent bed being in a first sorbent vessel, the potassium hydroxide-impregnated material being in a second sorbent vessel, and the hydride chemisorbent, as employed for polishing of the effluent to ensure high hydride removal, being in a third sorbent vessel. Each of the respective sorbent vessels in multi-vessel arrangements of the invention can be of a same or different character, and each bed may be sized and constructed for optimal chemisorption operation, with respect to bed diameter, bed height, particle size, bed void volume, allowable pressure drop, temperature, pressure, flow rate, etc., by design techniques well-known to those skilled in the chemisorbent and effluent abatement art.

The invention also contemplates the use of potassium hydroxide-impregnated gaseous phosphorus removal material in a composite sorbent bed containing the potassium hydroxide-impregnated material as well as a hydride chemisorbent material, interspersed with one another.

It will be appreciated that the type and variety of arrangements utilizing the potassium hydroxide-impregnated chemisorbent for gaseous phosphorus removal, alone, or in combination with hydride chemisorbents of varying type, can be widely varied in specific applications of the present invention.

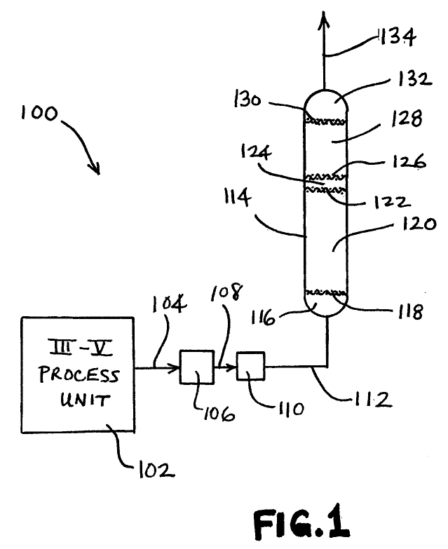

Referring now to the drawing, FIG. 1 is a schematic representation of a semiconductor manufacturing process facility 100 according to one embodiment of the invention.

The semiconductor manufacturing facility 100 includes a III-V process unit (“III-V PROCESS UNIT”) 102 in which semiconductor device manufacture takes place, involving use of phosphine as a source reagent, e.g., for chemical vapor deposition of phosphorus, for doping of a semiconductor substrate with phosphorus atoms, etc.).

The process unit 102 produces a gaseous effluent that is discharged from the unit in line 104 and flowed to vacuum pump 106. The vacuum pump 106 serves to maintain the pressure of the upstream process (e.g., a low pressure CVD reactor in process unit 102) at a suitably low level.

From vacuum pump 106, the effluent passes in line 108 to cold trap 110. The cold trap 110 may be cooled by water at a temperature on the order of 10-15° C., as supplied from the water utility of the semiconductor manufacturing plant.

The cold trap operates to condense phosphorus from the effluent stream, so that the gaseous phosphorus content of the effluent is reduced to part-per-million (by volume) levels.

From the cold trap 110, the gaseous phosphorus-reduced effluent flows in line 112 to the chemisorbent vessel 114 for chemisorbent treatment. The vessel may as shown be of elongate, vertically upstanding character, comprising a multiplicity of beds, in accordance with a preferred embodiment of the invention.

As illustrated, effluent enters the lower end of vessel 114 from line 112 and passes into lower plenum volume 116, from which it flows upwardly through the retaining grid 118 supporting main hydride chemisorbent bed 120. The gas then flows through grid 122 and the potassium hydroxide-impregnated material in intermediate bed 124 and thereafter through support grid 126 and hydride chemisorbent polishing bed 128, which is confined in position by top grid 130. The gas flowing through the sequential beds then exits the chemisorbent treatment, passing from polishing bed 128 into headspace 132 at the upper end of the vessel. From the headspace 132, the treated gas is discharged from the vessel in line 134, for release to the atmosphere, or other treatment or disposition.

The chemisorbent material in each of the successive beds 120, 124 and 128 in vessel 114 may be of particulate form, e.g., granules, pellets, or the like, and of appropriate size and surface area for effecting the desired level of effluent abatement in the respective zones.

The sorbent beds 120, 124 and 128 may be sized on fundamental design principles, to accommodate the volumetric flow of the effluent gas passed therethrough, so that hydrodynamically, the gas flows are processed in an efficient manner to achieve the desired level of abatement.

The potassium hydroxide-impregnated chemisorbent material utilized in the invention may be readily prepared by contacting the substrate material with an aqueous solution of potassium hydroxide and then drying the material to provide a potassium hydroxide residue in and/or on the support material. For such purpose, the support material should be of a high surface area character, e.g., having at least 10 meters² of surface area per gram, and more preferably at least 50 meters² of surface area per gram, as determined by mercury porosimetry or other suitable surface area determination method. The loading of potassium hydroxide on the support material may be at any suitable level, e.g., in a range of from about 0.01 gram to about 0.5 gram of KOH per gram of support material, and more preferably in a range of from about 0.02 to about 0.2 gram of KOH per gram of support material.

The invention thus provides a mixed or multi-layer chemisorbent arrangement for dry scrubbing of effluent gases.

In dry scrubbing systems, a wide range of chemistries is available for treating hazardous gases. Depending on the specific application, certain chemistries, or variations of chemistries, are optimal for treatment. While it is possible to optimize a particular resin mix or layered resin system for any given set of process conditions, it is often impossible to anticipate the operational variation of process conditions. This, in turn, often leads to situations in which there is a significant change in challenge to the scrubber medium during continued operation of a gas treatment system.

For example, a process that normally flows lower amounts of gas through a gas scrubbing system at high concentrations may have need to increase the ballast (e.g., carrier gas) on a regular, though intermittent, basis. Not only does such increase of ballast gas in the effluent decrease the residence time of the effluent in the dry scrubber unit (since the residence time is inversely proportional to the volumetric flow rate of the effluent gas), such increase in ballast gas flow rate also reduces the inlet concentration of scrubbable gas that is flowed to the dry scrubbing unit. This is a significant problem for many dry scrubbing chemistries, since many of such chemistries are optimized for low-flow, high-concentration effluent streams. Conversely, other chemistries perform optimally at low inlet concentrations of the scrubbable gas species, and do not require a long contact time with the effluent gas stream in order to achieve the desired removal of the target scrubbable gas species.

The present invention in another aspect addresses such problem of changing process conditions, specifically substantial variations in flow rate and/or concentration of the scrubbable gas species in the effluent stream, by providing a combination of chemical scrubbing species, e.g., in a layered scrubber arrangement and/or in a multi-component mixture of dry scrubbing materials, to achieve more robust scrubber operation, against changing effluent gas flows and/or amounts of scrubbable gas species that are flowed to the dry scrubbing system for effluent treatment.

This approach involves utilization of two or more chemistries to operate at extremes within an operating window of dry scrubber operation, so that chemistries adapted for one extreme of the operating window are combined with chemistries adapted for another, or others, of the operating window conditions. The dry scrubber materials embodying these respective chemistries can be mixed, blended or layered with one another for achieving efficient operability over the full window of operating conditions.

The ratios of each of the respective dry scrubbing materials to one another will depend on the frequency of change of conditions in the effluent dry scrubbing process. For example, effluent dry scrubbing processes that run more often at high concentrations of a specific scrubbable component, but sometimes at very low concentrations, will require a different mix of chemisorbent materials than a process that normally runs at consistently lower concentrations. Specific applications, then, are accommodated by a “tailored” resin mix, e.g., by separate sequential zones of differing chemisorbent material, or by interspersed mixture of different dry scrubbing materials, or by a combination of both approaches.

The invention in such “full operating window” mode of operation may be embodied in a dry scrubbing system for treatment of effluent from an upstream effluent-generating process to remove scrubbable gas species therefrom, within an operating window of process conditions involving substantial variation in flow rate and/or concentration of the scrubbable gas species during operation of the system, such system comprising:
a first dry scrubbing material arranged for contact with the effluent, wherein the first dry scrubbing material is (i) effective under process conditions constituting a first operating regime within the operating window of process conditions to achieve at least a predetermined level of removal of the scrubbable gas species from the effluent, and (ii) less effective outside of the first operating regime within said operating window of process conditions to achieve at least the predetermined level of removal of the scrubbable gas species from the effluent;
a second dry scrubbing material arranged for contact with said effluent, wherein the second dry scrubbing material is (i) effective under process conditions constituting a second operating regime within the operating window of process conditions to achieve at least the predetermined level of removal of the scrubbable gas species from the effluent, and (ii) less effective outside of the second operating regime within the operating window of process conditions to achieve at least the predetermined level of removal of the scrubbable gas species from the effluent; and
wherein effluent from the upstream effluent-generating process is arranged to contact both of the first dry scrubbing material and the second dry scrubbing material, and the first dry scrubbing material and the second dry scrubbing material together are effective to achieve at least the predetermined level of removal of the scrubbable gas species from the effluent, over the entire range of process conditions in the process operating window.

In such combinatorial approach utilizing differing dry scrubber materials to accommodate variations in process conditions, scrubber materials such as hydride scrubbing media and/or acid gas scrubbing media can be employed. Hydride gas scrubber materials include, without limitation, copper carbonate, basic copper carbonate, copper oxide, copper hydroxide, copper sulfate, zinc oxide, nickel oxide, potassium hydroxide, magnesium hydroxide, potassium iodide, silver oxide, activated carbon, molecular sieve, alumina, and silica gel. Acid gas scrubber materials include, without limitation, copper carbonate, basic copper carbonate, copper hydroxide, copper sulfate, lithium hydroxide, potassium thiosulfate, sodium thiosulfate, iron oxide, basic zinc oxide, calcium hydroxide, manganese oxide, calcium oxide, activated carbon, aluminum silicate, molecular sieve, aluminum oxide, silica gel, and potassium hydroxide.

It will therefore be seen that the combinatorial approach of the invention, involving use of differing dry scrubbing materials, is advantageously utilized to provide a dry scrubbing system that will accommodate all variations of process conditions within the window of operation for the scrubbing process.

Accordingly, by using combinatorial scrubbing media in accordance with the invention, the process conditions of the upstream process unit or facility (that produces the effluent that must be treated) can be allowed to widely vary. This enables the upstream process operation to be less restricted in its degrees of freedom, since the combinatorial scrubbing media will accommodate wide variations of process conditions within the operating window of the upstream process.

The invention therefore contemplates an effluent treatment system including combinatorial dry scrubbing media, in which the effluent varies substantially with time in the flow rate and/or concentration of the target scrubbable species in the effluent. As an example, the effluent treatment system of the invention is able to accommodate the combined effluent deriving from a number of upstream tools in a semiconductor manufacturing facility, in which the effluent can widely vary, e.g., as necessary for custom production of integrated circuitry products, wafer substrates, etc.

The combinatorial chemisorbent approach of the invention enlarges the operating window of the upstream effluent-generating process. As a result, the instrumentation, monitoring and process control necessary for the upstream process are correspondingly simplified, and set point limits on the operations of the respective tools in the upstream process facility can be relaxed, so that less monitoring and control, and less operator attention, are required. This in turn increases the throughput and productivity of the upstream process facility, and makes possible small custom fabs for custom chips and microelectronic devices that would otherwise be impractical.

The invention thereby achieves a substantial advance in the art of semiconductor manufacturing.

As illustrated by the multi-sorbent phosphorus and hydride effluent abatement system disclosed hereinabove as an illustrative embodiment, the multiple scrubbing media approach of the invention permits highly efficient removal of gaseous phosphorus without the attendant cost and complexity of highly refrigerated cold traps and without the special monitoring and analysis equipment that would otherwise be required to distinguish between gaseous phosphorus and phosphine to achieve a useful lifetime of the phosphine removal chemistry that is employed.

The features and advantages of the invention are more fully shown by the following illustrative examples.

### EXAMPLE 1

In this experiment, the test cell included a vessel 2 inches in inside diameter and 8 inches in height. The vessel was filled with chemisorbent material to constitute a bed therein that was fixedly retained in position by respective top and bottom screen elements.

Gas was flowed through the vessel from the bottom to the top thereof, and discharged at the upper end of the test cell vessel.

As an effluent gas source, a small reactor was constructed to simulate a chemical vapor deposition tool for phosphorus deposition. A five-point thermocouple was positioned in the reactor, to monitor temperature at the reactor inlet, the reactor outlet and at three equally spaced-apart points in the interior of the reactor between the inlet and outlet. The reactor was heated to 350° C. while phosphine and hydrogen were flowed through it, producing significant concentrations of elemental phosphorus (100-5000 ppm). The influent to the reactor contained 0.5% phosphine and was flowed at a superficial velocity of 1 centimeter per second through the reactor to generate the effluent passed to the test cell.

The test cell in this initial test contained copper carbonate/metal oxide-impregnated activated carbon chemisorbent, commercially available from ATMI, Inc. (Danbury, Conn., USA) as S525/P1 chemisorbent. Breakthrough of phosphorus occurred almost instantly.

The test was repeated at a temperature of 310° C. and breakthrough occurred after a few minutes.

The same test then was performed again using an ice bath cold trap on an analyzer sampling line receiving the discharged gas from the test cell, at the same process conditions. Breakthrough of phosphorus gas occurred in less than a minute.

The test cell then was emptied of the S525/P1 chemisorbent and loaded with a chemisorbent comprising the following composition by weight, based on the total weight of the composition: ˜53% CuO, ˜30% ZnO, ˜5% KOH coating, remainder filler. A 0.5% phosphine gas was flowed through the test cell at a superficial velocity of 1 centimeter/second and at temperature in a range of 370°-400° C. The flow was continued for 50 hours with no detection of phosphorus gas or phosphine in the effluent discharged from the test cell.

At the end of 50 hours, the phosphine source gas flowed to the simulated reactor was fully depleted, thereby necessitating termination of the test. The extended operation of the potassium hydroxide-impregnated material was therefore verified as an effective means for removing phosphorus gas, as well as phosphine, from gas containing same.

### EXAMPLE 2

In this experiment, the combinatorial approach of the invention was demonstrated for a process operating window including a first effluent regime (Process Regime 1) in which silane was present at a concentration of 4% by volume of the effluent stream, and a second effluent regime (Process Regime 2) in which silane was present at a concentration of 1% by volume of the effluent stream.

The effluent with this silane concentration variability was flowed through the chemisorbent vessel at a superficial linear velocity of 1 centimeter per second in both Process Regime 1 and Process Regime 2.

The chemisorbent used for treatment of the effluent included a Chemisorbent System A in combination with a Chemisorbent B.

The Chemisorbent System A included basic copper carbonate as a main chemisorbent and carbon impregnated with metal oxides as a polishing resin. Chemisorbent B comprised NiO as the active sorbent species.

The results of tests showed that in both process regimes of the operating window, the combination of Chemisorbent System A and Chemisorbent B provided good overall effluent treatment ability.

In Process Regime 1, Chemisorbent System A had an abatement removal capacity of 0.3 mole silane per liter of chemisorbent medium, while Chemisorbent B had an abatement removal capacity of 2.36 moles silane per liter of chemisorbent medium.

In Process Regime 2, Chemisorbent System A had an abatement removal capacity of 2.22 moles silane per liter of chemisorbent medium, while Chemisorbent B had an abatement removal capacity of 1.76 moles silane per liter of chemisorbent medium.

As shown by such results, Chemisorbent System A was less effective than Chemisorbent B in Process Regime 1, but more effective than Chemisorbent B in Process Regime 2, so that a major portion of the silane abatement removal was effected by Chemisorbent B in Process Regime 1, and a major portion of the silane abatement removal was effected by Chemisorbent System A in Process Regime 2. Thus, even under conditions involving a four-fold change in concentration of silane between Process Regime 1 and Process Regime 2, an effective silane removal capacity was maintained.

### EXAMPLE 3

In this experiment, the combinatorial approach of the invention was demonstrated for a process operating window including a first effluent regime (Process Regime 1) in which chlorine was present at a concentration of 0.5% by volume of the effluent stream, and a second effluent regime (Process Regime 2) in which chlorine was present at a concentration of 4% by volume of the effluent stream.

The effluent with this chlorine concentration variability was flowed through the chemisorbent vessel at a superficial linear velocity of 1 centimeter per second in both Process Regime 1 and Process Regime 2

The chemisorbent used for treatment of the effluent included CCL-2 chemisorbent, commercially available from Sud-Chemie AG (Munich, Germany) containing (by weight) 14% sodium thiosulfate, 1% aluminum silicate, 29% basic zinc carbonate and 56% aluminum oxide (Chemisorbent I), in combination with N-20 chemisorbent, commercially available from Sud-Chemie AG (Munich, Germany) as a combination of calcium hydroxide and iron (III) oxide (Chemisorbent II).

The results of tests showed that in both process regimes of the operating window, the combination of Chemisorbent I and Chemisorbent II provided good overall effluent treatment ability.

In Process Regime 1, Chemisorbent I had an abatement removal capacity of 1.66 moles chlorine per liter of chemisorbent medium, while Chemisorbent II had an abatement removal capacity of 0.71 mole chlorine per liter of chemisorbent medium.

In Process Regime 2, Chemisorbent I had an abatement removal capacity of 1.98 moles chlorine per liter of chemisorbent medium, while Chemisorbent II had an abatement removal capacity of 4.83 moles chlorine per liter of chemisorbent medium.

As shown by such results, Chemisorbent I was more effective than Chemisorbent II in Process Regime 1, but less effective than Chemisorbent II in Process Regime 2, so that a major portion of the chlorine abatement removal was effected by Chemisorbent I in Process Regime 1, and a major portion of the chlorine abatement removal was effected by Chemisorbent II in Process Regime 2. Thus, even under conditions involving an eight-fold change in concentration of chlorine between Process Regime 1 and Process Regime 2, an effective chlorine removal capacity was maintained.

The foregoing results show the benefit of utilizing a mixed chemisorbent approach to effluent abatement operations that are conducted in effluent process windows involving various and significantly different process regimes, e.g., entailing different inlet concentrations, flow rates, etc. Overall performance of the chemisorbent system can be optimized with respect to multiple chemisorbent species, to provide consistent effective abatement removal over the entire process window of operating conditions. By determinations such as those described in examples hereinabove, the optimal mix of chemisorbent materials can be determined for a series of upstream effluent-producing process units, as a function of the operating duration for the respective process units, e.g., where effluent species and concentrations vary with time, as a result of specific upstream process units being switched on and others being switched off at specific times during the overall operation of the upstream facility.

It will therefore be recognized that the combinatorial chemisorbent approach of the invention affords a substantial increase in effluent treatment efficiency and flexibility, in relation to prior art usage of chemisorbents. Such combinatorial approach permits the effluent treatment system to maintain a superior level of removal of undesired effluent stream components, even in circumstances in which concentrations, types and flows of effluent stream components are highly time-varying in character, and create widely divergent process regimes in which the corresponding effluent requires treatment.

While the invention has been illustratively described hereinabove with reference to specific aspects, features and embodiments, it will be recognized that the invention is not thus limited in scope, but rather extends to and incorporates other possible variations, modifications and alternative embodiments. The invention as claimed hereinafter therefore is intended to be broadly construed and interpreted, as including all such variations, modifications and alternative embodiments within its spirit and scope.

1. A dry scrubbing system for treatment of effluent from an upstream effluent-generating process to remove scrubbable gas species therefrom, within an operating window of process conditions involving substantial variation in flow rate and/or concentration of the scrubbable gas species during operation of the system, said system comprising:
a first dry scrubbing material arranged for contact with said effluent, wherein said first dry scrubbing material is (i) effective under process conditions constituting a first operating regime within said operating window of process conditions to achieve at least a predetermined level of removal of the scrubbable gas species from the effluent, and (ii) less effective outside of the first operating regime within said operating window of process conditions to achieve at least the predetermined level of removal of the scrubbable gas species from the effluent;
a second dry scrubbing material arranged for contact with said effluent, wherein said second dry scrubbing material is (i) effective under process conditions constituting a second operating regime within said operating window of process conditions to achieve at least the predetermined level of removal of the scrubbable gas species from the effluent, and (ii) less effective outside of the second operating regime within said operating window of process conditions to achieve at least the predetermined level of removal of the scrubbable gas species from the effluent; and
wherein effluent from the upstream effluent-generating process is arranged to contact both of said first dry scrubbing material and said second dry scrubbing material, and said first dry scrubbing material and said second dry scrubbing material together are effective to achieve at least said predetermined level of removal of the scrubbable gas species from the effluent, over the entire range of process conditions in said process operating window.

2. The system of claim 1, wherein the upstream effluent-generating process is conducted in a semiconductor manufacturing plant.

3. The system of claim 1, wherein the scrubbable gas species comprises at least one of hydrides, halides, acid gases and organometallic compounds.

4. The system of claim 1, wherein the scrubbable gas species comprises hydride gas species.

5. The system of claim 1, wherein the scrubbable gas species comprises phosphine.

6. The system of claim 1, wherein the scrubbable gas species comprises arsine.

7. The system of claim 1, wherein the scrubbable gas species comprises gaseous phosphorus.

8. The system of claim 1, wherein the first dry scrubbing material and the second dry scrubbing material are in a dry scrubbing vessel, in successive zones therein.

9. The system of claim 1, wherein the first dry scrubbing material and the second dry scrubbing material are interspersed with one another.

10. The system of claim 1, wherein the interspersed first dry scrubbing material and the second dry scrubbing material are in a dry scrubbing vessel.

11. The system of claim 1, wherein the first dry scrubbing material and the second dry scrubbing material are each independently selected from the group consisting of: (I) hydride scrubbing materials selected from the group consisting of copper carbonate, basic copper carbonate, copper oxide, copper hydroxide, copper sulfate, zinc oxide, nickel oxide, potassium hydroxide, magnesium hydroxide, potassium iodide, silver oxide, activated carbon, molecular sieve, alumina, and silica gel; and (II) acid gas scrubbing materials selected from the group consisting of copper carbonate, basic copper carbonate, copper hydroxide, copper sulfate, lithium hydroxide, potassium thiosulfate, sodium thiosulfate, iron oxide, basic zinc oxide, calcium hydroxide, manganese oxide, calcium oxide, activated carbon, aluminum silicate, molecular sieve, aluminum oxide, silica gel, and potassium hydroxide;
and wherein the first dry scrubbing material is different from the second dry scrubbing material.

12. The system of claim 1, wherein one of the first dry scrubbing material and the second dry scrubbing material comprises potassium hydroxide.

13. The system of claim 12, wherein said potassium hydroxide is impregnated on a support.

14. The system of claim 13, wherein said support comprises a material selected from the group consisting of molecular sieves, alumina, silica, carbon, macroreticulate polymers, and metal oxides.

15. The system of claim 13, wherein said support has a divided form.

16. The system of claim 15, wherein said support is in a particulate form.

17. The system of claim 1, wherein one of the first dry scrubbing material and the second dry scrubbing material comprises potassium hydroxide impregnated on a copper oxide/zinc oxide extrudate.

18. The system of claim 1, wherein the upstream effluent-generating process comprises a III-V semiconductor manufacturing process.

19. The system of claim 1, as joined in effluent-receiving relationship to an effluent-generating process.

20. The system of claim 19, comprising flow circuitry interconnecting the system and the effluent-generating process.

21. The system of claim 20, wherein the flow circuitry has a vacuum pump coupled thereto.

22. The system of claim 21, wherein the flow circuitry has a cold trap coupled thereto.

23. The system of claim 22, wherein the cold trap is downstream of the vacuum pump.

24. The system of claim 19, wherein the upstream effluent-generating process comprises a III-V semiconductor manufacturing process.

25. The system of claim 1, wherein the operating window of process conditions involves substantial variation in flow rate of the scrubbable gas species during operation of the system.

26. The system of claim 1, wherein the operating window of process conditions involves substantial variation in concentration of the scrubbable gas species during operation of the system.

27. The system of claim 1, wherein the operating window of process conditions involves substantial variation in flow rate and concentration of the scrubbable gas species during operation of the system.

28. The system of claim 1, wherein the first dry scrubbing material comprises a hydride-selective chemisorbent material, and the second dry scrubbing material comprises potassium hydroxide impregnated on a copper oxide/zinc oxide substrate.

29. The system of claim 1, further comprising a third dry scrubbing material arranged for contact with said effluent after said effluent has contacted said first dry scrubbing material and said second dry scrubbing material.

30. The system of claim 29, wherein the first dry scrubbing material comprises a hydride-selective chemisorbent material, the second dry scrubbing material comprises a gaseous phosphorus-selective chemisorbent material, and the third dry scrubbing material comprises a hydride-selective chemisorbent material.

31. The system of claim 1, wherein the first dry scrubbing material comprises a hydride-selective chemisorbent material, the second dry scrubbing material comprises a gaseous phosphorus-selective chemisorbent material.

32. A system for abating a gaseous phosphorus-containing effluent, comprising a dry scrubbing unit arranged for contact with said effluent, wherein said dry scrubbing unit comprises potassium hydroxide.

33. The system of claim 32, wherein the potassium hydroxide is impregnated on a support.

34. The system of claim 33, wherein the support comprises a material selected from the group consisting of molecular sieves, alumina, silica, carbon, macroreticulate polymers, and metal oxides.

35. The system of claim 33, wherein the support comprises metal oxide.

36. The system of claim 35, wherein the metal oxide comprises copper oxide and zinc oxide.

37. The system of claim 32, wherein the dry scrubbing unit comprises a dry scrubbing material chemisorptive for hydride gas.

38. The system of claim 37, wherein the hydride gas comprises phosphine.

39. The system of claim 32, wherein the effluent further comprises phosphine.

40. The system of claim 32, wherein the effluent derives from a semiconductor manufacturing facility.

41. The system of claim 32, wherein the effluent derives from a III-V process facility.

42. A method of abating gaseous phosphorus in an effluent including same, said method comprising contacting the effluent with potassium hydroxide.

43. The method of claim 42, wherein the potassium hydroxide is impregnated on a support.

44. The method of claim 43, wherein said support comprises a material selected from the group consisting of molecular sieves, alumina, silica, carbon, macroreticulate polymers, and metal oxides.

45. The method of claim 43, wherein said support has a divided form.

46. The method of claim 43, wherein said support is in a particulate form.

47. The method of claim 43, wherein the potassium hydroxide is impregnated on a copper oxide/zinc oxide substrate.

48. The method of claim 42, wherein the effluent derives from a semiconductor manufacturing process.

49. The method of claim 42, wherein the effluent derives from a III-V semiconductor manufacturing process.

50. A method of treatment of effluent from an upstream effluent-generating process to remove scrubbable gas species therefrom, within an operating window of process conditions involving substantial variation in flow rate and/or concentration of the scrubbable gas species, said method comprising:
contacting said effluent with a first dry scrubbing material, wherein said first dry scrubbing material is (i) effective under process conditions constituting a first operating regime within said operating window of process conditions to achieve at least a predetermined level of removal of the scrubbable gas species from the effluent, and (ii) less effective outside of the first operating regime within said operating window of process conditions to achieve at least the predetermined level of removal of the scrubbable gas species from the effluent;
contacting said effluent with a second dry scrubbing material, wherein said second dry scrubbing material is (i) effective under process conditions constituting a second operating regime within said operating window of process conditions to achieve at least the predetermined level of removal of the scrubbable gas species from the effluent, and (ii) less effective outside of the second operating regime within said operating window of process conditions to achieve at least the predetermined level of removal of the scrubbable gas species from the effluent; and
wherein said effluent contacts both of said first dry scrubbing material and said second dry scrubbing material, and said first dry scrubbing material and said second dry scrubbing material together are effective to achieve at least said predetermined level of removal of the scrubbable gas species from the effluent, over the entire range of process conditions in said process operating window.

51. The method of claim 50, wherein the upstream effluent-generating process is conducted in a semiconductor manufacturing plant.

52. The method of claim 50, wherein the scrubbable gas species comprises at least one of hydrides, halides, acid gases and organometallic compounds.

53. The method of claim 50, wherein the scrubbable gas species comprises hydride gas species.

54. The method of claim 50, wherein the scrubbable gas species comprises phosphine.

55. The method of claim 50, wherein the scrubbable gas species comprises arsine.

56. The method of claim 50, wherein the scrubbable gas species comprises gaseous phosphorus.

57. The method of claim 50, wherein the first dry scrubbing material and the second dry scrubbing material are in a dry scrubbing vessel, in successive zones therein.

58. The method of claim 50, wherein the first dry scrubbing material and the second dry scrubbing material are interspersed with one another.

59. The method of claim 58, wherein the interspersed first dry scrubbing material and the second dry scrubbing material are in a dry scrubbing vessel.

60. The method of claim 50, wherein the first dry scrubbing material and the second dry scrubbing material are each independently selected from the group consisting of: (I) hydride scrubbing materials selected from the group consisting of copper carbonate, basic copper carbonate, copper oxide, copper hydroxide, copper sulfate, zinc oxide, nickel oxide, potassium hydroxide, magnesium hydroxide, potassium iodide, silver oxide, activated carbon, molecular sieve, alumina, and silica gel; and (II) acid gas scrubbing materials selected from the group consisting of copper carbonate, basic copper carbonate, copper hydroxide, copper sulfate, lithium hydroxide, potassium thiosulfate, sodium thiosulfate, iron oxide, basic zinc oxide, calcium hydroxide, manganese oxide, calcium oxide, activated carbon, aluminum silicate, molecular sieve, aluminum oxide, silica gel, and potassium hydroxide;
and wherein the first dry scrubbing material is different from the second dry scrubbing material.

61. The method of claim 50, wherein one of the first dry scrubbing material and the second dry scrubbing material comprises potassium hydroxide.

62. The method of claim 61, wherein said potassium hydroxide is impregnated on a support.

63. The method of claim 62, wherein said support comprises a material selected from the group consisting of molecular sieves, alumina, silica, carbon, macroreticulate polymers, and metal oxides.

64. The method of claim 62, wherein said support has a divided form.

65. The method of claim 62, wherein said support is in a particulate form.

66. The method of claim 50, wherein one of the first dry scrubbing material and the second dry scrubbing material comprises potassium hydroxide impregnated on a copper oxide/zinc oxide substrate.

67. The method of claim 50, wherein the upstream effluent-generating process comprises a III-V semiconductor manufacturing process.

68. The method of claim 50, wherein flow circuitry interconnects the effluent-generating process and a dry scrubbing vessel containing the first dry scrubbing material and the second dry scrubbing material.

69. The method of claim 68, further comprising vacuum pumping the effluent from the effluent-generating process to the dry scrubbing vessel.

70. The method of claim 69, further comprising flowing the effluent from through a cold trap prior to its entering the dry scrubber vessel.

71. The method of claim 50, wherein the operating window of process conditions involves substantial variation in flow rate of the scrubbable gas species.

72. The method of claim 50, wherein the operating window of process conditions involves substantial variation in concentration of the scrubbable gas species.

73. The method of claim 50, wherein the operating window of process conditions involves substantial variation in flow rate and concentration of the scrubbable gas species.

74. The method of claim 50, wherein the first dry scrubbing material comprises a hydride-selective chemisorbent material, and the second dry scrubbing material comprises potassium hydroxide impregnated on a copper oxide/zinc oxide substrate.

75. The method of claim 50, further comprising contacting the effluent with a third dry scrubbing material after said effluent has contacted said first dry scrubbing material and said second dry scrubbing material.

76. The method of claim 75, wherein the first dry scrubbing material comprises a hydride-selective chemisorbent material, the second dry scrubbing material comprises a gaseous phosphorus-selective chemisorbent material, and the third dry scrubbing material comprises a hydride-selective chemisorbent material.

77. The method of claim 50, wherein the first dry scrubbing material comprises a hydride-selective chemisorbent material, the second dry scrubbing material comprises a gaseous phosphorus-selective chemisorbent material.

78. A method of treating effluent to provide a predetermined level of removal of at least one undesired species from the effluent, wherein the undesired species has a variable presence, concentration and/or flow rate constituting differing regimes of effluent treatment operation, said method comprising contacting the effluent with at least two different sorptive media for removal of said at least one undesired species, wherein each sorptive medium has differing removal efficiency for undesired species in at least two of said regimes of effluent treatment operation, and wherein said different sorptive media in combination provide a predetermined removal efficiency for said undesired species.
